(19) United States
(12) Patent Application Publication
(10) Pub. No.: US 2012/0101704 A1
(43) Pub. Date: Apr. 26, 2012

(54) METHOD FOR OPERATING AT LEAST ONE SENSOR OF A VEHICLE AND VEHICLE HAVING AT LEAST ONE SENSOR

(75) Inventor: Nikolas WAGNER, Eltville-Rauenthal (DE)

(73) Assignee: GM GLOBAL TECHNOLOGY OPERATIONS LLC, Detroit, MI (US)

(21) Appl. No.: 13/277,317

(22) Filed: Oct. 20, 2011

(30) Foreign Application Priority Data
Oct. 21, 2010 (DE) 102010049091.1

(51) Int. Cl. G06F 17/00; B60K 31/00

(52) U.S. Cl. 701/96; 701/300

(57) ABSTRACT

A method is provided for operating at least one sensor of a vehicle. The at least one sensor is configured for detecting objects lying within a predetermined detection range and the method includes, but is not limited to: position data emitted by at least one object is received by means of a receiving apparatus of the vehicle. In addition, a position of the at least one object is determined by means of the position data received from the at least one object and a comparison is made as to whether the determined position lies within the predetermined detection range of the at least one sensor. If the determined position lies within the predetermined detection range of the at least one sensor, it is further determined whether the at least one object is detected by the at least one sensor. If the at least one object is not detected by the at least one sensor, an instantaneous detection range of the at least one sensor is further determined by means of the determined position of the at least one object.

### CROSS-REFERENCE TO RELATED APPLICATION

This application claims priority to German Patent Application No. 102010049091.1, filed Oct. 21, 2010, which is incorporated herein by reference in its entirety.

### TECHNICAL FIELD

The technical field relates to a method for operating at least one sensor of a vehicle, a vehicle having at least one sensor, a computer program product, and a computer-readable medium.

### BACKGROUND

Known from EP 1 103 823 A2 is a method for adjusting a sensor of a vehicle to determine the distance and the direction of objects relative to the vehicle, in which the distance and directional angle of objects relative to the vehicle is detected continuously during the journey with the aid of the sensor, in which the objects are tracked in time and direction vectors are calculated, in which the relative position of the roadway with respect to the vehicle is determined from the direction vectors and from this the measured direction of travel is determined, in which the direction of travel of the vehicle is calculated continuously with the aid of a yaw-rate sensor and the vehicle speed, in which the difference between the directions of travel determined from the measured values of the sensor and the directions of travel determined by means of the yaw-rate sensor and the vehicle speed are calculated, and in which the angle misalignment of the sensor is calculated from the differences of the directions of travel. A sensor is provided for executing the method, whose adjusting means can be set automatically by drive means.

It is at least one object to provide a method for operating at least one sensor of a vehicle, a vehicle having at least one sensor, a computer program product, and a computer-readable medium, which can identify restricted functionality of the sensor. In addition, other objects, desirable features and characteristics will become apparent from the subsequent summary and detailed description, and the appended claims, taken in conjunction with the accompanying drawings and this background.

### SUMMARY

According to one embodiment, a method for operating at least one sensor of a vehicle, where the at least one sensor is configured for detecting objects lying within a predetermined detection range comprises the following steps. Position data emitted by at least one object is received by means of a receiving apparatus of the vehicle. In addition, a position of the at least one object is determined by means of the position data received from the at least one object and a comparison is made as to whether the determined position lies within the predetermined detection range of the at least one sensor. If the determined position lies within the predetermined detection range of the at least one sensor, it is further determined whether the at least one object is detected by the at least one sensor. If the at least one object is not detected by the at least one sensor, an instantaneous detection range of the at least one sensor is further determined by means of the determined position of the at least one object.

The method for operating the at least one sensor of the vehicle according to an embodiment whereby the position of the at least one object is determined by means of the received position data and if the determined position lies within the predetermined detection range of the at least one sensor, it is determined whether the object is detected by the sensor and, if the object is not detected by the sensor, an instantaneous detection range of the at least one sensor is determined by means of the determined position of the at least one object, enables a restricted functionality of the at least one sensor to be identified. This is advantageously accomplished by means of components already provided in the vehicle, in particular by means of data of the receiving apparatus.

The method further has the advantage that in addition to identifying the restricted functionality of the at least one sensor or identifying a restricted range of the sensor, an instantaneous detection range, i.e., a value corresponding to the reduced range of the at least one sensor as accurately as possible, is additionally determined. Consequently, the degree of restriction of the functionality of the at least one sensor can additionally be determined.

This starts from the consideration that the position of the at least one object can be determined both by means of the data determined by the at least one sensor and also by means of the position data received from the at least one object and therefore there is some redundancy. The embodiments utilize this redundancy in an advantageous manner.

The at least one sensor is preferably configured as an acoustic sensor, in particular as an ultrasound sensor, or as an electromagnetic sensor, in particular a run-time-based sensor, for example as a radar sensor or as a lidar sensor, or as an optical sensor, for example as an optical camera. The said sensors, which are also designated as environment sensors, are increasingly provided for vehicles. Depending on the physical principle for detecting objects, these sensors can be subject to limitations or have detection problems in cases of heavy precipitation, hail, snow, or mist, i.e., particles in the air between sensor and object, and when the sensor surface is contaminated or covered, since the emitted energy is already reflected by the dirt or the precipitation particles. In particular with lidar sensors, the functionality can be significantly restricted in the said cases. The identification of a restricted functionality is therefore particularly highly advantageous for the said types of sensors.

In a further embodiment, a message is additionally output inside the vehicle if the at least one object is not detected by the at least one sensor. The vehicle occupants, in particular the vehicle driver, can thereby advantageously have their attention drawn to the restricted range or functionality of the at least one sensor and thereby warned and optionally carry out measures to restore the full functionality of the sensor, for example if this is contaminated or covered. The message can therefore include a warning and/or a request for cleaning the at least one sensor.

In another embodiment, the determined instantaneous detection range is transmitted to at least one driver assistance system of the vehicle. The at least one driver assistance system is preferably selected from the group consisting of an adaptive speed regulating system, an emergency braking system, and a navigation system. At the same time, preferably at least one parameter of the at least one driver assistance system is adapted to the determined instantaneous detection range. For example, a desired speed of the adaptive speed regulating system, which is also designated as ACC (Adaptive Cruise Control), is reduced or an automatic emergency braking of the vehicle by means of the emergency braking system is introduced earlier. The embodiments therefore advantageously enable driver assistance systems, in particular systems for the active safety of the vehicle, to be increasingly adapted to the instantaneous conditions and thereby further improved.

The position of the at least one object can be a position relative to the vehicle. This has the advantage that a relative position to the vehicle can be determined in a particularly simple manner by means of data determined by the at least one sensor.

In a further embodiment of the method, the determination of the position of the at least one object by means of the position data received from the at least one object includes a determination of a distance of the at least one object from the vehicle. The instantaneous detection range of the at least one sensor can be determined in such a manner that the determined distance of the at least one object from the vehicle forms an upper limit of the instantaneous detection range. An instantaneous range of the at least one sensor determined in such a manner advantageously agrees to the highest possible extent with the actual reduced range of the sensor.

The receiving apparatus is preferably part of a vehicle-to-vehicle communication apparatus and/or a vehicle-to-infrastructure communication apparatus of the vehicle. Corresponding communication apparatus are increasingly provided for vehicles, whereby the receiving apparatus can advantageously be integrated in these communication apparatuses.

In an embodiment, the position data emitted by the at least one object is additionally provided with information about the time of its determination. As a result, a temporal synchronization of the position data with data of the at least one sensor can be accomplished. Furthermore, the position data emitted by the at least one object can additionally be provided with information about the dimensions of the at least one object. As a result, the position of the at least one object can be determined very precisely by means of the position data received from the at least one object.

In a further embodiment of the method, a speed of the at least one object is additionally determined by means of position data received from the at least one object. As a result, relevant objects, for example, another vehicle driving in front of the vehicle, can be distinguished in a particularly simple manner from irrelevant objects in the surroundings of the vehicle. If position data are received from a plurality of objects within the predetermined detection range and respectively one position of the plurality of objects is determined, it is preferably determined whether the plurality of objects are each detected by the at least one sensor. If at least two of the plurality of objects are not detected by the at least one sensor, the instantaneous detection range of the at least one sensor is thereby determined by means of the determined position of that non-detected object which has the shortest distance from the vehicle.

A vehicle is also provided that comprises at least one sensor, where the at least one sensor is configured for detecting objects within a predetermined detection range. The vehicle additionally comprises a receiving apparatus configured for receiving position data emitted by at least one object and a position determining apparatus configured for determining a position of the at least one object by means of the position data received from the at least one object. The vehicle further comprises a first determination apparatus configured to determine whether the at least one object is detected by the at least one sensor if the determined position lies within the predetermined detection range of the at least one sensor. Furthermore, the vehicle comprises a second determination apparatus configured to determine an instantaneous detection range of the at least one sensor by means of the determined position of the at least one object if the at least one object is not detected by the at least one sensor.

A computer program product is also provided that, when it is implemented on a processing unit of a vehicle, instructs the processing unit to execute the following steps. The processing unit is instructed to receive position data emitted by at least one object by means of a receiving apparatus of the vehicle. The processing unit is further instructed to determine a position of the at least one object by means of the position data received from the at least one object and compare whether the determined position lies within the predetermined detection range of the at least one sensor. If the determined position lies within the predetermined detection range of the at least one sensor, the processing unit is instructed to determine whether the at least one object is detected by the at least one sensor. Furthermore, if the at least one object is not detected by the at least one sensor, the processing unit is instructed to determine an instantaneous detection range of the at least one sensor by means of the determined position of the at least one object. A computer-readable medium on which a computer program product according to the said embodiment is stored is also provided in accordance with an embodiment.

The vehicle, the computer program product, and the computer-readable medium according to the application exhibit the advantages already specified in connection with the method according to the application, which will not be listed again at this point to avoid repetitions.

The vehicle in the aforesaid embodiments is preferably a motor vehicle, in particular an automobile or a truck.

### BRIEF DESCRIPTION OF THE DRAWINGS

The present invention will hereinafter be described in conjunction with the following drawing figures, wherein like numerals denote like elements, and:

FIG. 1 shows a flow diagram of a method for operating at least one sensor of a vehicle according to one embodiment; and

FIG. 2 shows a vehicle having a sensor according to one embodiment.

### DETAILED DESCRIPTION

The following detailed description is merely exemplary in nature and is not intended to limit application and uses. Furthermore, there is no intention to be bound by any theory presented in the preceding background or the following detailed description.

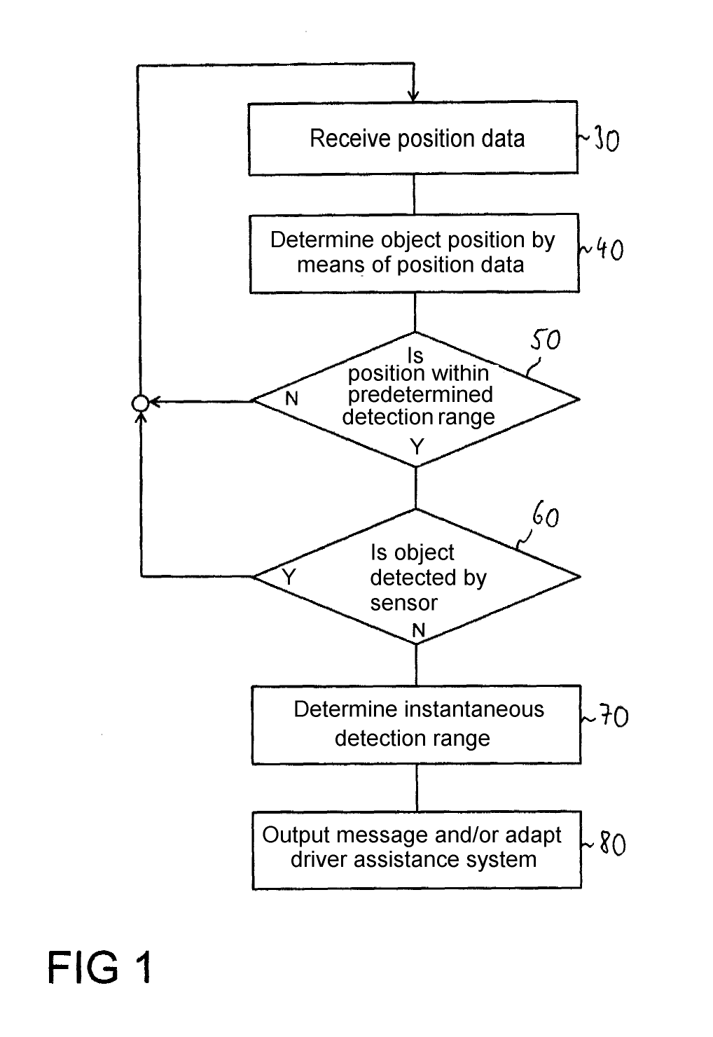

FIG. 1 shows a flow diagram of a method for operating at least one sensor of a vehicle, where the at least one sensor is configured for detecting objects within a predetermined detection range, according to one embodiment of the application. The at least one sensor is typically configured as an acoustic sensor, in particular as an ultrasound sensor, or as an electromagnetic sensor, in particular a run-time-based sensor, for example as a radar sensor or as a lidar sensor, or as an optical sensor, for example as an optical camera. The vehicle is preferably a motor vehicle, in particular an automobile.

In the embodiment shown, in a step 30 position data emitted by at least one object is received by means of a receiving apparatus of the vehicle, where the receiving apparatus is preferably part of a vehicle-to-vehicle communication apparatus and/or a vehicle-to-infrastructure communication apparatus of the vehicle. In a step 40, a position of the at least one object is determined by means of position data received from the at least one object. Furthermore, in a step 50 a comparison is made to determine whether the determined position lies within the predetermined detection range of the at least one sensor.

If the determined position does not lie within the predetermined detection range of the at least one sensor, steps 30 and optionally 40 are executed repeatedly. If the determined position lies within the predetermined detection range of the at least one sensor, it is determined in a step 60 whether the at least one object is detected by the at least one sensor.

If the at least one object is detected by the at least one sensor, step 30 and optionally steps 40 and 50 are executed repeatedly. In addition, a confidence level for measurement data of the at least one sensor can optionally be increased in one or more driver assistance systems of the vehicle. If the at least one object is not detected by the at least one sensor, in a step 70 an instantaneous detection range of the at least one sensor is determined by means of the determined position of the at least one object.

In the embodiment shown in a step 80 a message is additionally output inside the vehicle if the at least one object is not detected by the at least one sensor. The message can be an acoustic and/or an optical message. It is also possible for a message to be output inside the vehicle if the determined instantaneous detection range of the at least one sensor lies below a predetermined threshold value where the threshold value can in particular be selected with reference to the predetermined detection range.

Additionally or alternatively in step 80, the determined instantaneous detection range is transmitted to at least one driver assistance system of the vehicle, for example, an adaptive speed regulating system, an emergency braking system, and/or a navigation system. At least one parameter of the at least one driver assistance system is adapted to the determined instantaneous detection range. Furthermore, the position data emitted by the at least one object can be provided with information about the time of its determined, i.e. with a time stamp, for example, with a time stamp of a CAN bus system.

In the event of objects, in particular vehicles, not being identified by the at least one sensor from a determined distance, the embodiment shown thus enables a range of the sensor reduced to this distance, for example, due to precipitation, to be concluded. Vehicle occupants, in particular the vehicle driver, can thereby have their attention drawn to a restricted range of the sensor and thereby warned accordingly and driver assistance systems can be adapted thereto, for example, by reducing the desired speed of the adaptive speed regulating system.

In the event of a general non-identification of objects, i.e. if no object for which position data are available, is detected by the sensor 1, in an extended embodiment contamination or covering of the sensor can additionally be concluded and the attention of the occupants of the vehicle 2, in particular the driver, can be drawn to this and for example, be requested to clean the sensor 1.

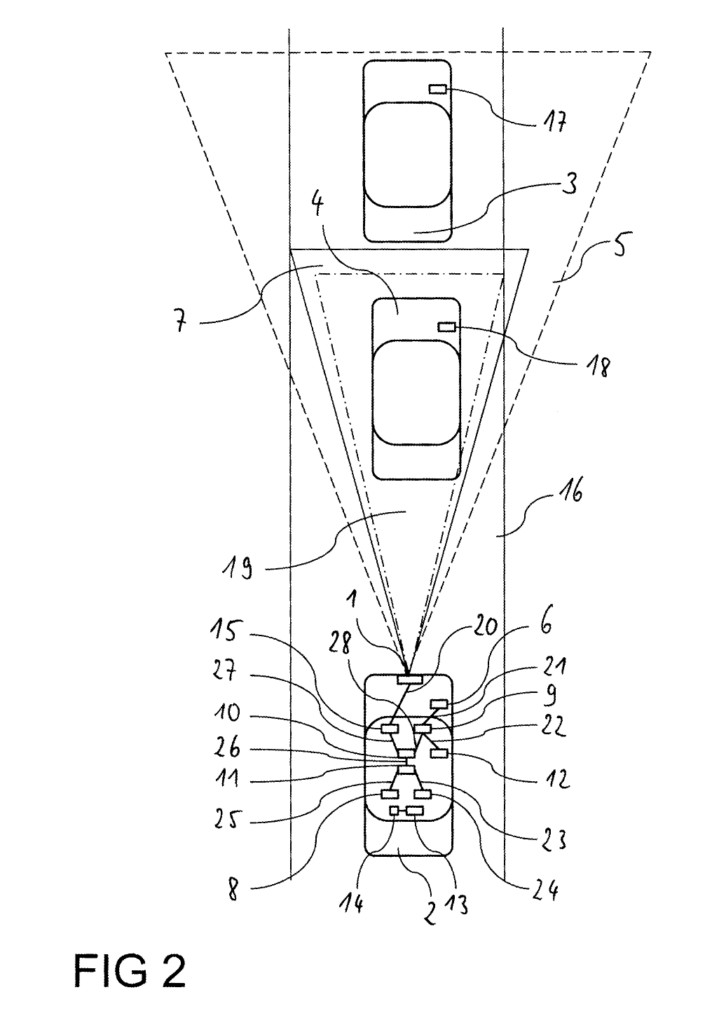

FIG. 2 shows a vehicle 2 with a sensor 1 according to an embodiment. In the embodiment shown, the vehicle 2 is a motor vehicle in the form of an automobile. The sensor 1 is configured to detect objects within a predetermined detection range 5, depicted schematically by means of a dashed line. For example, the sensor 1 is a radar sensor or a lidar sensor. The vehicle 2 is located on a roadway 16 which, in the embodiment shown, is single-track in the direction of travel of the vehicle 2. In front of the vehicle 2, two objects 3 and 4 in the form of other automobiles are located on the roadway 16 within the predetermined detection range 5 of the sensor 1.

The vehicle 2 has a receiving apparatus 6 which is in particular configured to receive position data emitted by the transmitting apparatus 17 of the object 3 and by a transmitting apparatus 18 of the object 4. The receiving apparatus 6 is part of a vehicle-to-vehicle or of a vehicle-to-infrastructure communication apparatus of the vehicle 2 and the transmitting apparatuses 17 and 18 are part of a vehicle-to-vehicle or of a vehicle-to-infrastructure communication apparatus of the other vehicles, i.e. the objects 3 or 4.

In addition, the vehicle 2 has position determining apparatus 9 which is configured for determining the position in particular of the objects 3 and 4 by means of the position data received from these objects. For this purpose, the position determining apparatus 9 is connected to the receiving apparatus via a connecting line 21. In the embodiment shown, the position determining apparatus 9 is configured for determining the position of the objects 3 and 4 by means of the received position data and by means of a position of the vehicle 2 determined by a position determining apparatus 12 of the vehicle 2. For this purpose the position determining apparatus 12 is connected to the position determining apparatus 9 via a connecting line 22 and is typically part of a navigation system of the vehicle 2.

The vehicle 2 furthermore has a position determining apparatus 15 which is configured to determine a position of at least one object detected by the sensor 1 by means of data from the sensor 1. For this purpose, the position determining apparatus 15 is connected to the sensor 1 via a signal line 20. In addition, the vehicle 2 has a first determination apparatus 10. The first determination apparatus 10 is configured to determine whether those objects from which position data have been received by means of the receiving apparatus 6 and their determined position lie within the predetermined detection range 5 of the sensor 1, are detected by the sensor 1. To this end, the first determination apparatus 10 is connected to the position determining apparatus 9 via a connecting line 28 and to the position determining apparatus 15 via a connecting line 27. The first determination apparatus 10 is further connected to a second determination apparatus 11 of the vehicle 2 via a connecting line 26, where the second determination apparatus 11 is configured to determine an instantaneous detection range 7 of the sensor 1 by means of a determined position of at least one object not detected by the sensor 1, whose determined position lies within the predetermined detection range 5.

In the embodiment shown, an actual detection range 19 of the sensor 1, depicted schematically by means of a dot-dash line, is reduced compared with the predetermined detection range 5, for example, by heavy precipitation in the form of rain, snow or hail and/or mist. The object 3 is therefore located outside the actual detection range 19 and is consequently not detected by the sensor 1. In the embodiment shown, the object 4 is located inside the actual detection range 19 and is therefore detected by the sensor 1.

Accordingly, in the embodiment shown, the first determination apparatus 10 determines that the object 3 is not determined by the sensor 1 although it is located within the predetermined detection range 5. The second determination apparatus 11 determines an instantaneous detection range 7 of the sensor 1 depicted schematically by a continuous line, by means of the determined position of the object 3. In this case, the instantaneous detection range 7 of the at least one sensor 1 is determined in such a manner that a determined distance of the object 3 from the vehicle 2 forms an upper limit of the instantaneous detection range 7.

In an alternative embodiment the second determination apparatus 11 determines the instantaneous detection range 7 of the sensor 1 by means of the determined position of the object 4, i.e., that determined object having the greatest distance from the vehicle 2. At the same time, the determined distance 4 from the vehicle 2 forms the lower limit of the instantaneous detection range 7. In addition, in the embodiment shown, the second determination apparatus 11 transmits the determined instantaneous detection range 7 to at least one driver assistance system 8 of the vehicle 2, for example, to an adaptive speed regulating system, an emergency braking system and/or a navigation system. The driver assistance system 8 is thereby configured to adapt at least one parameter to the determined instantaneous detection range 7.

Furthermore, in the embodiment shown the vehicle 2 has an output apparatus 24 configured for outputting a message inside the vehicle 2 if at least one object, whose determined position lies within the predetermined detection range 5 is not detected by the sensor 1. The output apparatus 24 is preferably configured as an acoustic and/or an optical output apparatus and can, for example, be part of a combi-instrument and/or an information and entertainment system of the vehicle 2. The second determination apparatus 11 is thereby connected to the driver assistance system 8 via a connecting line 25 and to the output apparatus 24 via a connecting line 23.

In the event of a general non-identification of objects, i.e., if no object for which position data are available, is detected by the sensor 1, contamination or covering of the sensor can further be concluded and the attention of the occupants of the vehicle 2, in particular the driver, can be drawn to this and for example, be requested to clean the sensor 1.

Furthermore, in the embodiment shown the vehicle 2 has a processing unit 13 and a computer-readable medium 14, where a computer program product is stored on the computer-readable medium 14, which when executed on the processing unit 13, instructs the processing unit to perform the said steps of the method according to the application, in particular the embodiment shown in FIG. 1, by means of the said elements. To this end, the processing unit 13 is connected directly or indirectly to the said components in a manner not shown in detail.

The embodiment shown starts from the consideration that systems for the active safety of vehicles are in particular based on so-called environment sensors such as, for example, radar sensors, lidar sensors, and/or optical cameras which measure the surroundings relative to the vehicle, e.g. in the form of distances and angles. By means of systems having so-called vehicle-to-vehicle communication, also known as V2V communication (“vehicle to vehicle” communication) or vehicle-to-infrastructure communication, also known as V2R communication (“vehicle to roadside” communication), the relative position of two vehicles to one another or the relative position of one vehicle to an object of the traffic infrastructure can also be determined. If a vehicle is fitted with V2V and with environment sensors, the relative position to a preceding vehicle, also fitted with V2V is therefore determined both via V2V and by environment sensor and there is a redundancy. The said embodiment advantageously uses this redundancy.

The embodiment shown therefore enables an identification of a restricted range of an environment sensor and contamination of a defect of the sensor by using additional V2V equipment and consequently a use of technology provided in the vehicle to avoid sensor errors in active safety systems.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for operating at least one sensor of a vehicle, the at least one sensor is configured for detecting objects within a predetermined detection range and the method comprises
receiving position data emitted by at least one object with a receiving apparatus of the vehicle;
determining a position of the at least one object with the position data received from the at least one object;
determining whether the position lies within the predetermined detection range of the at least one sensor;
determining whether the at least one object is detected by the at least one sensor if the position lies within the predetermined detection range of the at least one sensor; and
determining an instantaneous detection range of the at least one sensor with the position of the at least one object if the at least one object is not detected by the at least one sensor.

2. The method according to claim 1, further comprising generating a message inside the vehicle if the at least one object is not detected by the at least one sensor.

3. The method according to claim 1, further comprising transmitting the instantaneous detection range to at least one driver assistance system of the vehicle.

4. The method according to claim 3, wherein the at least one driver assistance system is an adaptive speed regulating system

5. The method according to claim 3, wherein the at least one driver assistance system is an emergency braking system.

6. The method according to claim 3, wherein at least one parameter of the at least one driver assistance system is configured to the instantaneous detection range.

7. The method according to claim 1, wherein the position of the at least one object is a relative position that is relative to the vehicle.

8. The method according to claim 1, wherein the determining of the position of the at least one object with the position data received from the at least one object comprises determining a distance of the at least one object from the vehicle.

9. The method according to claim 8, wherein the instantaneous detection range of the at least one sensor is determined in such a manner that the distance of the at least one object from the vehicle forms an upper limit of the instantaneous detection range.

10. The method according to claim 1, wherein the position data emitted by the at least one object is additionally provided with information about a time of determination.

11. The method according to claim 1, further comprising:
receiving position data from a plurality of objects within the predetermined detection range;
determining one position of the plurality of objects;
determining whether the plurality of objects are each detected by the at least one sensor; and
determining the instantaneous detection range of the at least one sensor with the position of a non-detected object that has a shortest distance from the vehicle if at least two of the plurality of objects are not detected by a sensor.

12. A vehicle, comprising:
at least one sensor configured to detecting objects within a predetermined detection range;
a receiving apparatus configured to receive position data emitted by at least one object;
a position determining apparatus configured to determine a position of the at least one object with the position data received from the at least one object;
a first determination apparatus configured to determine whether the at least one object is detected by the at least one sensor if the position lies within the predetermined detection range of the at least one sensor; and
a second determination apparatus configured to determine an instantaneous detection range of the at least one sensor with the position of the at least one object if the at least one object is not detected by the at least one sensor.

13. The vehicle according to claim 12, wherein the at least one sensor is configured as an acoustic sensor.

14. The vehicle according to claim 12, wherein the at least one sensor is an electromagnetic sensor.

15. The vehicle according to claim 12, further comprising at least one driver assistance system that is configured to receive the instantaneous detection range.

16. The vehicle according to claim 15, wherein the at least one driver assistance system is an adaptive speed regulating system.

17. The vehicle according to claim 15, wherein the at least one driver assistance system is an emergency braking system.

18. The vehicle according to claim 15, wherein the at least one driver assistance system is a navigation system.

19. A computer readable medium embodying a computer program product, said computer program product comprising:
an operating program for operating at least one sensor of a vehicle, the at least one sensor is configured for detecting objects within a predetermined detection range, the operating program configured to:
receive position data emitted by at least one object with a receiving apparatus of the vehicle;
determine a position of the at least one object with the position data received from the at least one object;
determine whether the position lies within the predetermined detection range of the at least one sensor;
determine whether the at least one object is detected by the at least one sensor if the position lies within the predetermined detection range of the at least one sensor; and
determine an instantaneous detection range of the at least one sensor with the position of the at least one object if the at least one object is not detected by the at least one sensor.

20. The computer readable medium embodying the computer program product according to claim 19, the operating program further configured to generate a message inside the vehicle if the at least one object is not detected by the at least one sensor.
